(19) United States
(12) Patent Application Publication
(10) Pub. No.: US 2022/0318685 A1
(43) Pub. Date: Oct. 6, 2022

(54) BIASED BASED DELEGATION IN MACHINE LEARNING MODELS

(71) Applicant: International Business Machines Corporation, Armonk, NY (US)

(72) Inventors: Gandhi Sivakumar, Bentleigh (AU); Lynn KWOK, Bundoora (AU); Kushal S. Patel, Pune (IN); Sarvesh S. Patel, Pune (IN)

(21) Appl. No.: 17/223,158

(22) Filed: Apr. 6, 2021

(51) Int. Cl. G06N 20/20

(52) U.S. Cl. CPC G06N 20/20

(57) ABSTRACT

An approach is provided in which the approach receives a job request, which includes biasing parameters, from an entity operating in a distributive cognitive system. The approach evaluates the biasing parameters against a set of machine learning model bias characteristics corresponding to a set of machine learning models and selects one of the machine learning models based on the evaluating. The approach assigns the selected machine learning model to the entity to perform the job request.

### BACKGROUND

A cognitive network (CN) is a new type of data network that utilizes cutting edge technology from several research areas to solve problems in current networks (e.g., machine learning, knowledge representation, etc.). Cognitive networks include a cognition plane, which is a decentralized system that enables self-management, self-control, and self-optimization of networks and service platforms. The cognition plane exploits data mining, reasoning and machine learning algorithms and techniques to extract knowledge on the status of the network and service platforms.

Cognitive models, also referred to as “cognitive entities,” are aimed to remember the past, interact with humans, continuously learn, and refine future responses. Their cognitive capabilities enrich human needs automation based on time and situation and provide more dynamic responses and user satisfaction. Machine learning models are a major component of cognitive entities.

A cognitive network typically includes many machine learning models with different functions. Machine learning models typically include input feature sets and a mathematical model to compute outcomes. The outcomes vary based on the type of machine leaning model, its algorithm, input training corpus, and other interrelated fields. A machine learning model may be classification-dependent or regression-dependent based on the need of the environment.

### BRIEF SUMMARY

According to one embodiment of the present disclosure, an approach is provided in which the approach receives a job request, which includes biasing parameters, from an entity operating in a distributive cognitive system. The approach evaluates the biasing parameters against a set of machine learning model bias characteristics corresponding to a set of machine learning models and selects one of the machine learning models based on the evaluating. The approach assigns the selected machine learning model to the entity to perform the job request.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary high-level diagram depicting a router function that learns of, and assigns, feature-biased machine learning models to job requests;

FIG. 4 is an exemplary flowchart showing steps taken in system initialization and demon plaguing;

FIG. 5 is an exemplary flowchart showing steps taken in bias based machine learning model discovery;

FIG. 6 is an exemplary flowchart showing steps taken to validate fake features;

FIG. 7 is an exemplary flowchart showing steps by a job routing model to manage machine learning information;

FIG. 8 is an exemplary flowchart showing steps taken in selecting a bias based machine learning model and dispatching a job to the bias based machine learning model;

FIG. 9 is an exemplary diagram depicting a router function performing a primary-secondary discovery process and requesting/receiving bias based machine learning model information; and

FIG. 10 is an exemplary diagram depicting a model feature set table and machine learning model grouping.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

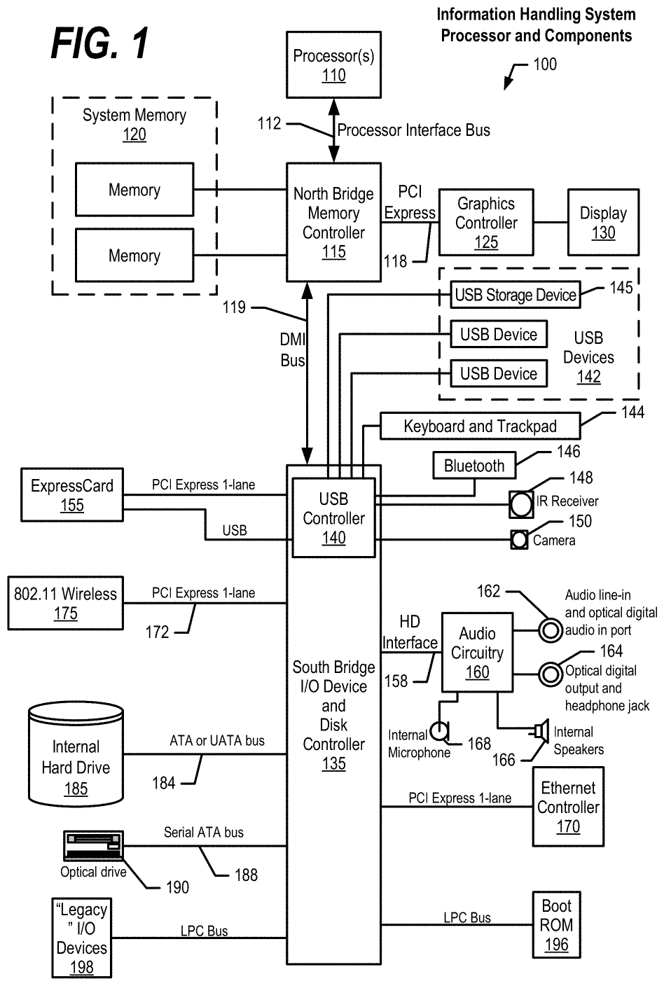

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicates between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

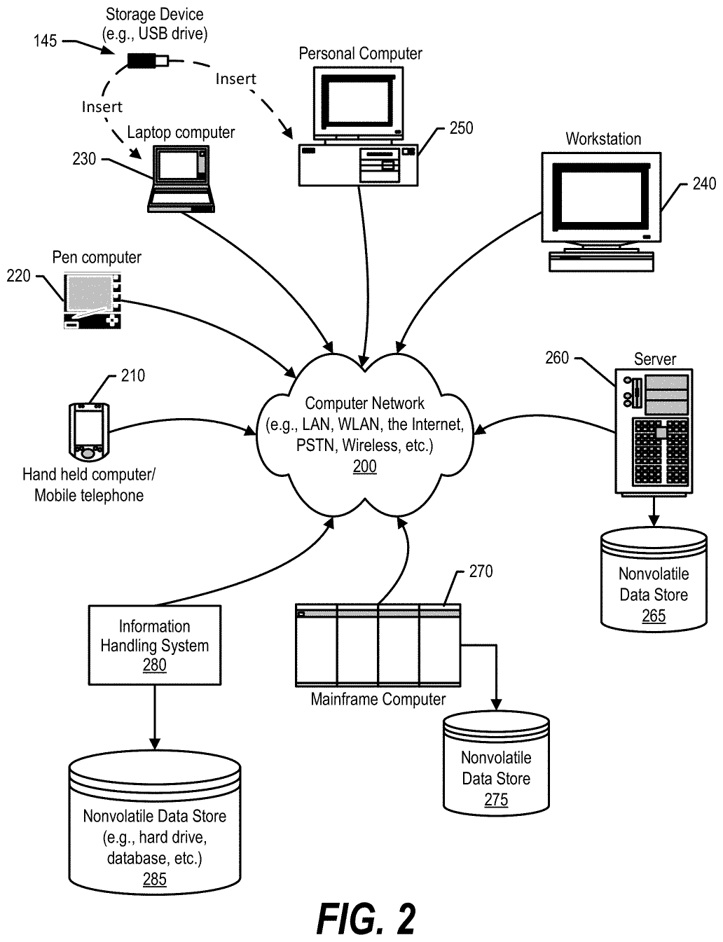

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, a cognitive network is a new type of data network that utilizes cutting edge technology from several research areas to solve problems in current networks. One of the common emerging ecosystems for dissimilar machine learning modeling is a 5G service orchestration layer. In a 5G domain level orchestration, the cognitive orchestration services are deployed and utilize various machine learning models to achieve real time cognition capabilities for user data.

Since machine learning models are trained using a particular training data set, machine learning models are inherently biased. Machine learning model biasing is a systematic pattern of deviation from normal or rationality in judgment based on the input parameters and feature sets of machine learning models. The machine learning models operate on the feature sets to make the decision of the real-time problems. In biased-based functionalities of a machine learning model, the machine learning model is more focused (or defocused) towards some of the parameters to make decisions. For example, if a machine learning model of loan approval uses a feature set as {A, B and C}, then in an A-based machine learning model biasing, the machine learning model produces outcomes relevant to the A feature and ignores the other features in the set. At the time of urgent job computing requirements of complex tasks, the biasing is one of the major factors in machine learning model outcome generation that is gaining popularity.

However, in today's multi-domain cognitive systems, there is no way to select a particular machine learning model for favoritism orientation (biasing) to produce a situational outcome for submitted jobs. In distributed cognitive systems, there is no way a machine learning model in the orchestration plane is discoverable and grouped based on their biasing nature and invoked when needed. In a situation where an external cognitive entity needs a job to be computed in a biased mode, there is no way that a machine learning model router (e.g., job submission router) can sense the request and route the job to respective machine learning models to produce a faster and desired outcome for the biasing expectations of the external cognitive entity.

In addition, there is no way that machine learning models in the cognitive system's orchestration plane can discover each other and collect peer information about their individual bias parameters along with the training corpus information, feature-sets and related artifacts of the machine learning model and which can be used for biased oriented delegation of the jobs. In distributed cognitive systems, or multi-domain cognitive systems in the cloud deployment with many machine learning models attachments, consequences arise when some of the jobs need to be biased on some parameters, such as for external analytics purpose or situational urgency and external software biasing requirements.

Today's machine learning model job submission router considers machine learning model activation status and workloads while assigning jobs, but the job submission router does not take into consideration the biased feature-sets and their importance values to select a target machine learning model. Because of this, customer interacting machine learning models in the orchestration plane follow the job submission router process and the jobs are submitted to the respective models. In addition, there is no way that the biasing requests are transferred to a correct basing model in the orchestration plane because of lagging metadata exchange based on biased parameters and weightage factors.

Furthermore, today's job submission routers are not able to collect information from machine learning models regarding basing capabilities and feature functions. A machine learning model may be different operating on a different feature set, running on different training data corpus, and may have deployed on a different computer infrastructure with different price/performance characters. Because of these complex factors associated with each machine learning model, it becomes very difficult to choose a correct machine learning model to compute results for a given task.

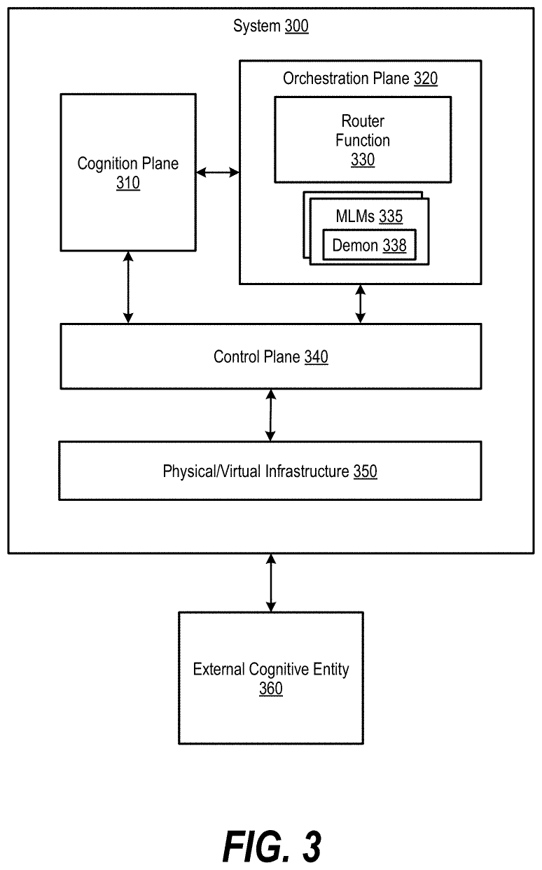

FIGS. 3 through 10 depict an approach that can be executed on an information handling system that resolves the aforementioned problems by enabling the job submission router to track machine learning model biasing and dispatch new biased-based jobs to an appropriately biased machine learning model. As there are multiple machine learning models floating in various layers that are hosted with different feature alignment and biasing attributes, the approach provides a mechanism in a job submission router to discover machine learning models and capture their corresponding bias emphasis functionality.

The approach works with machine learning model and artificial intelligence (AI) job submitter functions in multi-domain cognitive systems and programmability framework by providing a primary-secondary discovery model for finding machine learning model characteristics in the cognitive system. The approach further initiates an inquiry for feature biasing and feature-set's individual weightage identification. The approach further considers the parameters for biased-based computing in the machine learning model to complete a job and create machine learning model groups in the router functions accordingly.

FIG. 3 is an exemplary high-level diagram depicting a router function that learns of, and assigns, feature-biased machine learning models to job requests. System 300 includes cognition plane 310, which embraces a monitor-analyses-plan-execute process governed by a knowledge-based approach for automated and autonomic network management. In particular, cognition plane 310 supports machine learning for monitoring and analysis steps, as well as for creating new knowledge. Cognition plane 310 focuses on determining changes in physical/virtual infrastructure 350 and orchestration plane 320 enforces the actions onto control plane 340.

Orchestration plane 320 includes router function 330, also referred to herein as a job submission router. Router function 330 computes feature-biased attributes in machine learning models 335 and articulates feature sets for augmented or deflected feature sets and accordingly selects a suitable feature-biased machine learning model for influence emphasized delegation in the router functions. Each of machine learning models 335 instances include demon 338.

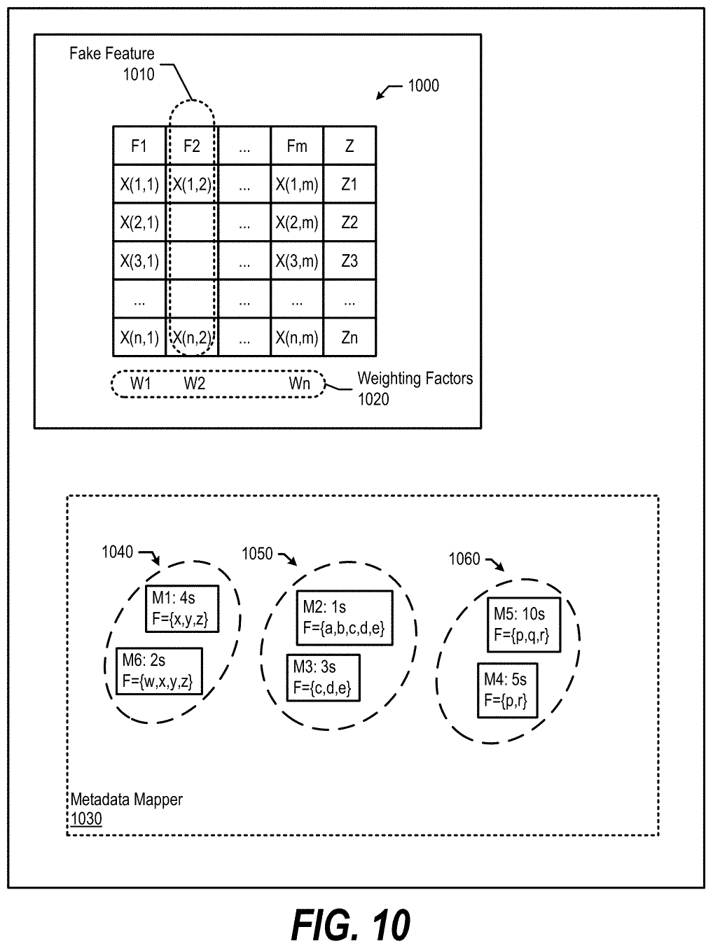

As discussed herein, demon 338 collects information pertaining to its corresponding machine learning model 335 and shares the information with router function 330. In one embodiment, demon 338 computes the attributes, feature-sets, etc. and works with its respective machine learning model 335 to gather and exchange the data. Router function 330 further considers supporting attributes such as a training corpus, feature-set distribution for classification or regression, and fake feature exploration of the machine learning model (see FIG. 10 and corresponding text for further details).

Router function 330 collects biasing factors and importance assignment from each of machine learning models 335 using a primary-secondary discovery protocol and creates virtual groups of the machine learning models based on the biasing features and the respective weightage. Metadata classes are generated for each machine learning model that saves the biasing attributes and importance driven classification utilized during feature-biased machine learning model delegation of job requests (see FIG. 10 and corresponding text for further details).

Orchestration plane 320 also tracks fake feature exploration and accordingly notifies router function 330 of fake features to utilize during feature-biased machine learning model selection. Fake features are features used in machine learning model by value extrapolation. Fake features are not actual values, but rather added by the machine learning model itself. For example, if a loan application requires {A, B, C} as attributes and the machine learning model is trained for {A, B}, then the machine learning model inserts a false value for {C} for the next set of computations. When external cognitive entity 360 requests a particular biasing parameter, router function 330 avoids selecting a machine learning model that has the particular biasing parameter as a fake feature.

In one embodiment, router function 330 enables improved results in multi-user cognitive systems by tracking dynamic biasing knowledge of machine learning models and selecting the best suitable feature-biased machine learning model 335 for a submitted job requested by external cognitive entity 360. In one embodiment, router function 330 provides a way to communicate with peer machine learning models to exchange feature-sets, weightage factors, and biasing attributes, and add entries in a local table that router function 330 utilizes to generate more accurate outcomes.

In one embodiment, router function 330 auto-discovers model biasing to use in transferring a submitted job based on biased-focused distancing. In this embodiment, router function 330 adopts dynamic machine learning model addition and deletion in a local mapping database to deliver real-time user benefits.

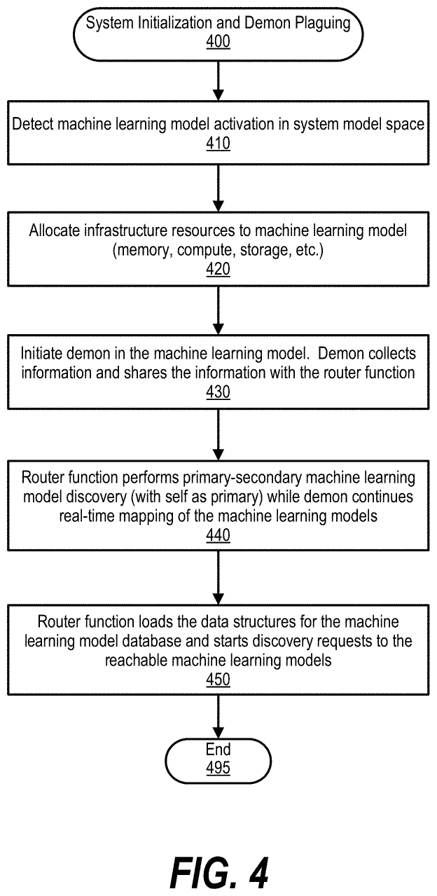

FIG. 4 is an exemplary flowchart showing steps taken in system initialization and demon plaguing. Processing commences at 400 whereupon, at step 410, the process detects a machine learning model activation in system 300's model space. For example, the activation may be performed by a system administrator, or be part of a system initialization when other processes start. At step 420, the process allocates infrastructure resources to the machine learning model from base resources, such as memory resources, compute resources, storage resources, etc.

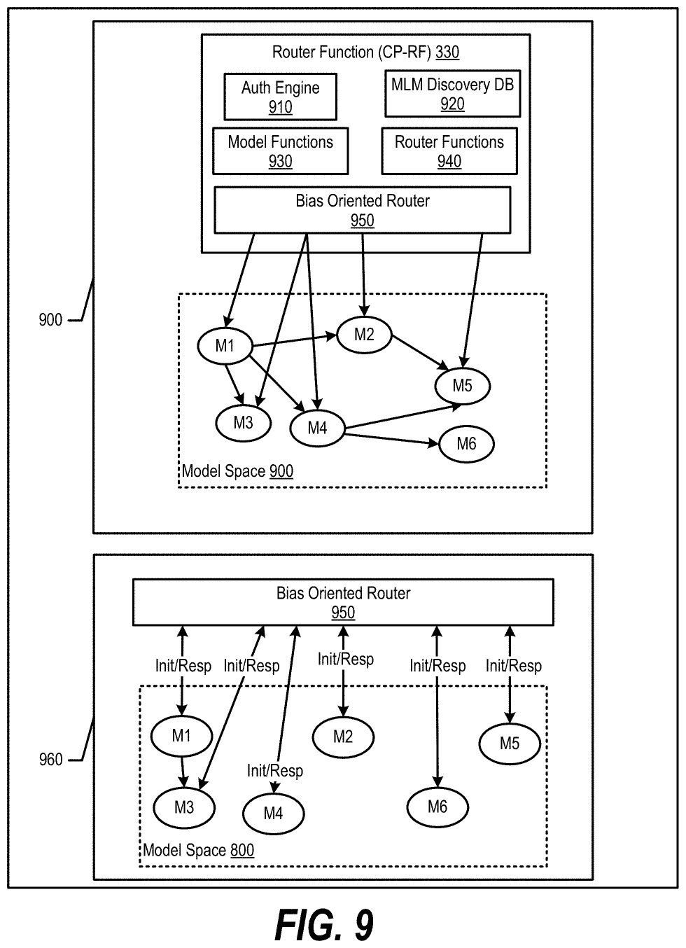

At step 430, the process initiates a demon (demon 338) within the machine learning model and collects information pertaining to the machine learning model and shares the information with router function 330. In one embodiment, the demon computes the attributes, feature-sets, etc. and works with the machine learning model to gather and exchange the data. At step 440, the process (router function 330) performs a primary-secondary machine learning model discovery while the demon performs real-time mapping of the machine learning models in the orchestration plane (see FIG. 9 and corresponding text for further details).

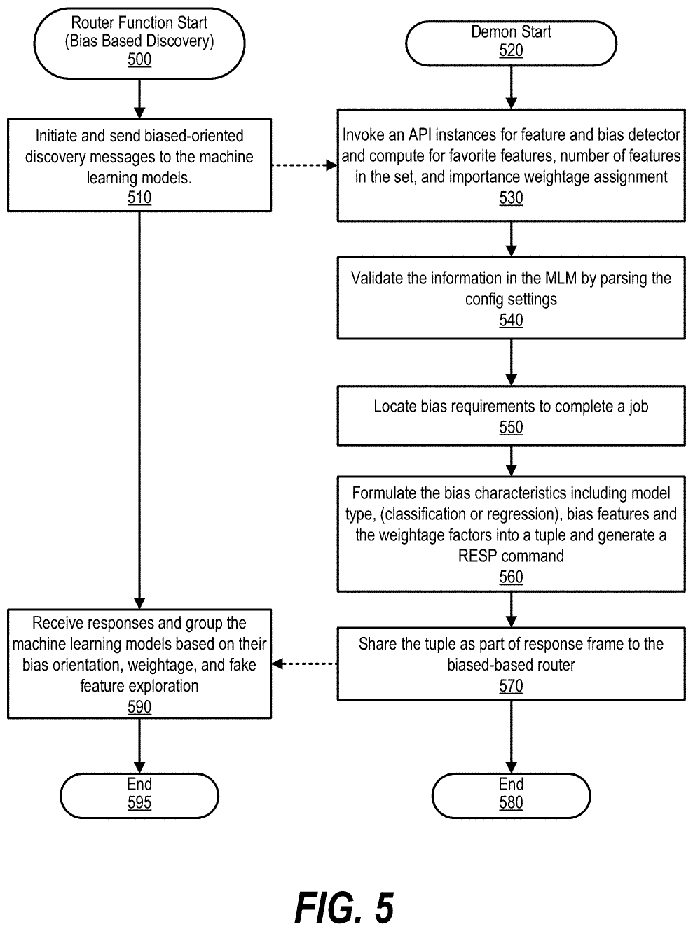

At step 450, the process (router function 330) loads the data structures for the machine learning model database and starts discovery requests to other reachable machine learning models, at which point feature-biased machine learning model discovery begins (see FIG. 5 and corresponding text for further details). FIG. 4 processing thereafter ends at 495.

FIG. 5 is an exemplary flowchart showing steps taken in bias based machine learning model discovery. Processing commences at 500 whereupon, at step 510, the process initiates and sends biased-oriented discovery messages to machine learning models 335. In one embodiment, router function 330 invokes in-band authorization services and collects universally unique identifiers (UUIDs) of the machine learning models as part of the authorization service.

Machine learning model demon processing commences at 520 whereupon, at step 530, the demon invokes an API instances for feature and bias detection and computes favorite features, number of features in the set, and importance weightage assignments. At step 540, the demon validates the information in the machine learning model by parsing the configuration settings.

At step 550, the demon locates bias requirements to complete a job and, at step 560, the demon formulates the model type, (classification or regression), bias features and the weightage factors into a tuple and generate a RESP command, such as DISCOVERY_RESP=<feature-set, Bias-feature[ ], weightage_LIST[ ]>. At step 570, the demon shares the tuple as part of a response frame to router function 330's bias based router. Demon processing thereafter ends at 580.

Returning back to router function processing, at step 590, the router function receives responses and groups the machine learning models based on their bias orientation, weightage, and fake feature exploration (see FIG. 10 and corresponding text for further details). Router function processing thereafter ends at 595.

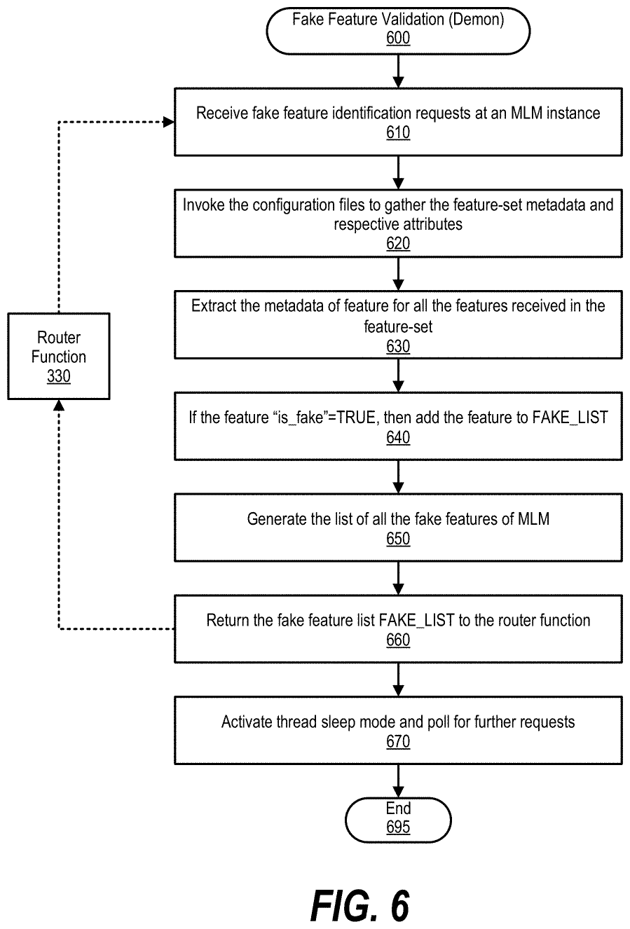

FIG. 6 is an exemplary flowchart showing steps taken to validate fake features. In one embodiment, demon 338, inside machine learning model 335, performs the steps shown in FIG. 6. Processing commences at 600 whereupon, at step 610, the process receives a fake feature identification request from router function 330. At step 620, the process invokes a set of configuration files to gather feature-set metadata and respective attributes corresponding to the fake feature request. At step 630, the process extracts the metadata of the feature for each of the features received in the feature-set.

At step 640, if the feature “is_fake”=TRUE, the process adds the feature to a fake feature list. At step 650, the process generates the list of all the fake features of the machine learning model (see FIG. 10 and corresponding text for further details). At step 660, the process returns the fake feature list “FAKE_LIST” to router function 670. At step 670, the process activates a sleep mode thread and polls for further requests. FIG. 6 processing thereafter ends at 695.

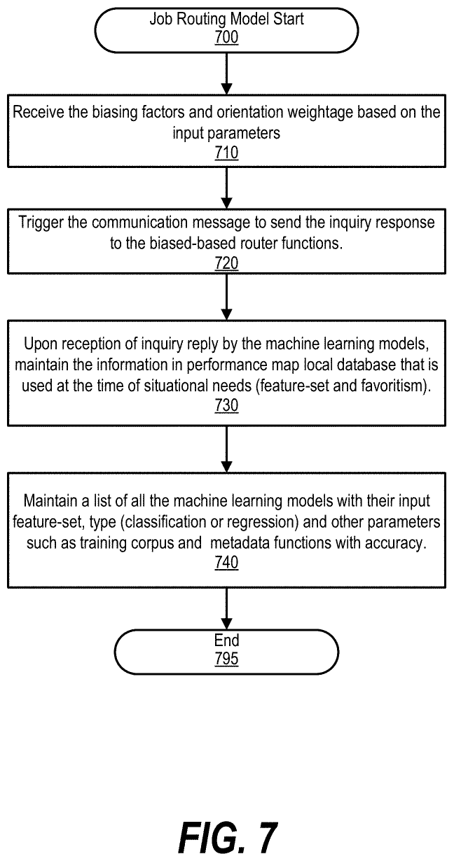

FIG. 7 is an exemplary flowchart showing steps by a job routing model to manage machine learning information. Processing commences at 700 whereupon, at step 710, the process receives expected biasing factors and orientation weightage from the biased-based router function. At step 720, the process triggers a communication message to send an inquiry response to the biased-based router functions.

At step 730, upon reception of the inquiry reply by the machine learning models, the process (e.g., service job submitter router) keeps the information in a performance map local database that is used at the time of situational needs (e.g., feature-set and favoritism). At step 740, the process (e.g., router function 330) maintains a list of the machine learning models with their input feature-set, type (classification or regression) and other parameters such as training corpus and metadata functions with accuracy. FIG. 7 processing thereafter ends at 795. In one embodiment, the process iteratively learns feature-biased machine learning model selections to reach quicker selection decisions and perform incremental group updates.

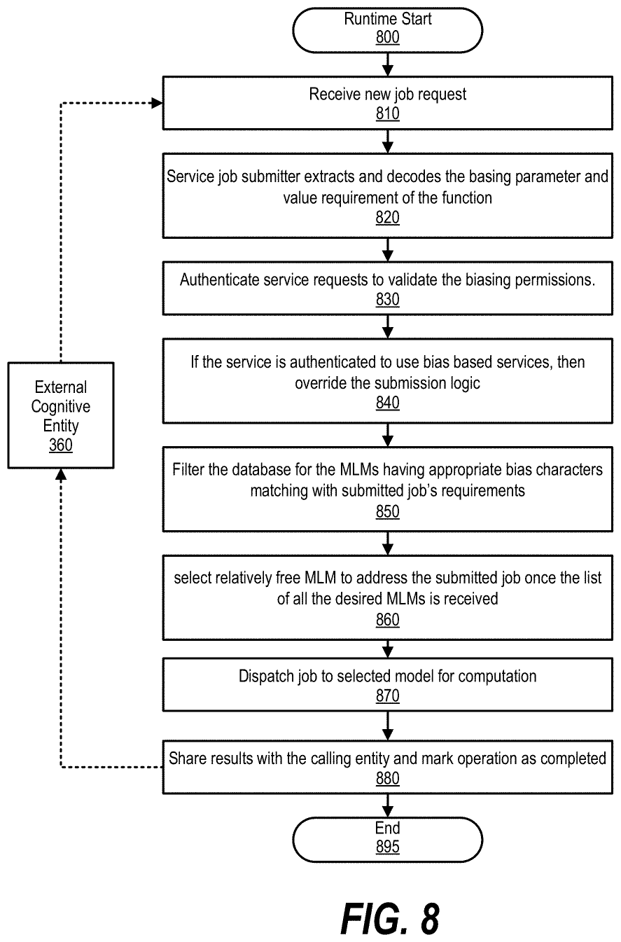

FIG. 8 is an exemplary flowchart showing steps taken in selecting a bias based machine learning model and dispatching a job to the bias based machine learning model. FIG. 8 processing commences at 800 whereupon, at step 810, the process receives a new job request from external cognitive entity 360. At step 820, the process extracts and decodes the basing parameter and value requirements of the function in the request.

At step 830, the process authenticates the service request to validate the biasing permissions. At step 840, the process overrides the submission logic if the service is authenticated to use bias based services. At step 850, the process filters the database for the machine learning models having appropriate bias characters matching the submitted job's requirements.

At step 860, the process selects relatively free machine learning models to address the submitted job once the list of all the desired machine learning models is received. At step 870, the process dispatches the job to the selected model for computation and, at step 880, the process shares the results with external cognitive entity 360 and marks the operation as completed. FIG. 8 processing thereafter ends at 895.

FIG. 9 is an exemplary diagram depicting a router function performing a primary-secondary discovery process and requesting/receiving bias based machine learning model information.

Diagram 900 shows that router function 330 includes authentication engine 910, machine learning model discovery database 920, model functions 930, router functions 940, and biased oriented router 950. Authentication engine 910 ensures the data/metadata and other information is exchanged between authorized entities in orchestration plane 320. Machine learning model discovery database 920 stores data structures of the machine learning model database. Model functions 930 include a set of functions on which a machine learning model works, such as a mathematical computing function Y=f(x) where f is function that performs as sqrt( ) operation. Router functions 940 include a process that takes care of job routing in system 300. When system 300 detects a machine learning model activation in model space 900 within orchestration plane 320, system 300 initiates a demon (demon 338) in the machine learning model that collects information and shares the information with router function 330.

Bias oriented router 950 performs a primary-secondary machine learning model discovery while the demon performs real-time mapping of the machine learning models in the orchestration plane's model space 900. Bias oriented router 950 loads the data structures for the machine learning model database into machine learning model discovery database 920 and starts discovery requests to other reachable machine learning models M1, M2, M3, M4, M5, and M6. In one embodiment, when a new machine learning model is activated, router function 330 performs group inclusion steps as discussed herein and the updates in machine learning model groups are updated so that future requests can consider new models as well.

Diagram 960 shows that bias oriented router 950 sends “DISCOVERY_INT” requests to the reachable machine learning models M1, M2, M3, M4, M5, and M6. Diagram 960 shows discovery responses “DISCOVERY_RESP” from the various machine learning models. In one embodiment, each DISCOVERY_RESP includes information such as a triple <feature-set, Bias-feature[ ], weightage_LIST[ ]>.

FIG. 10 is an exemplary diagram depicting a model feature set table and machine learning model grouping. Router function 330 requests information from the machine learning models about their fake features, and in response the machine learning models send the information back to router function 330. As discussed above, the fake features are the features used in machine learning model by value extrapolation. Fake features are not the actual values, but rather added by the machine learning model itself.

Router function 330 tracks the fake features to select appropriate machine learning models at runtime because, for example, if a job function needs to be more weighted on function X, then router function 330 does not select a machine learning model with fake features X.

Table 1000 includes weightage factors 1020 and fake features 1010. System 300 uses table 1000 to map fake feature exploration and notify router function 330 of the fake features during machine learning model selection.

Metadata mapper 1030 shows machine learning model groupings for same feature sets and response times. Grouping 1040 includes M1 and M6 because they both have x, y, z features with similar response times. Grouping 1050 includes M2 and M3 because they both have c, d, e features with similar response times. And, grouping 1060 includes M4 and M5 because they both have p, r features.

Turning to machine learning model M6, M6 has a feature set: F={w, x, y, z} where “w” is biasing feature in the model. As such, when a request is received by router function 330 from external cognitive entity 360 to compute a job with biasing of “w”, then router function 330 invokes M6 because the model has the same biasing parameters and will therefore produce better outcomes as per the expectation of cognitive biasing.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method comprising:
receiving a job request from an entity operating in a distributive cognitive system, wherein the job request comprises one or more biasing parameters;
evaluating the one or more biasing parameters against a plurality of machine learning model bias characteristics corresponding to a plurality of machine learning models;
selecting one of the plurality of machine learning models based on the evaluating; and
assigning the job request to the selected machine learning model.

2. The method of claim 1 further comprising:
receiving, from each of the plurality of machine learning models, their corresponding one of the plurality of bias characteristics prior to receiving the job request, wherein each of the plurality of bias characteristics comprise one or more bias features and one or more weightage factors.

3. The method of claim 2 further comprising:
grouping the plurality of machine learning models into a set of machine learning model groups based on their corresponding one or more bias features and their one or more weightage factors.

4. The method of claim 3 further comprising:
receiving a list of fake features from each of the plurality of machine learning models; and
grouping the plurality of machine learning models into the set of machine learning model groups based on their corresponding one or more bias features, their one or more weightage factors, and their corresponding list of fake features.

5. The method of claim 4 further comprising:
identifying one of the set of machine learning model groups that comprises at least one fake feature that matches at least one of the one or more biasing parameters; and
omitting the identified machine learning model group from the evaluating.

6. The method of claim 1 further comprising:
determining whether the distributed cognitive system is authenticated to use a bias-based service; and
dispatching the job request to the selected machine learning model in response to determining that the distributed cognitive system is authenticated to use the bias based service.

7. The method of claim 1 wherein each one of the plurality of machine learning models is instantiated on an orchestration plane in the distributive cognitive system.

8. An information handling system comprising:
one or more processors;
a memory coupled to at least one of the processors;
a set of computer program instructions stored in the memory and executed by at least one of the processors in order to perform actions of:
receiving a job request from an entity operating in a distributive cognitive system, wherein the job request comprises one or more biasing parameters;
evaluating the one or more biasing parameters against a plurality of machine learning model bias characteristics corresponding to a plurality of machine learning models;
selecting one of the plurality of machine learning models based on the evaluating; and
assigning the job request to the selected machine learning model.

9. The information handling system of claim 8 wherein the processors perform additional actions comprising:
receiving, from each of the plurality of machine learning models, their corresponding one of the plurality of bias characteristics prior to receiving the job request, wherein each of the plurality of bias characteristics comprise one or more bias features and one or more weightage factors.

10. The information handling system of claim 9 wherein the processors perform additional actions comprising:
grouping the plurality of machine learning models into a set of machine learning model groups based on their corresponding one or more bias features and their one or more weightage factors.

11. The information handling system of claim 10 wherein the processors perform additional actions comprising:
receiving a list of fake features from each of the plurality of machine learning models; and
grouping the plurality of machine learning models into the set of machine learning model groups based on their corresponding one or more bias features, their one or more weightage factors, and their corresponding list of fake features.

12. The information handling system of claim 11 wherein the processors perform additional actions comprising:
identifying one of the set of machine learning model groups that comprises at least one fake feature that matches at least one of the one or more biasing parameters; and
omitting the identified machine learning model group from the evaluating.

13. The information handling system of claim 8 wherein the processors perform additional actions comprising:
determining whether the distributed cognitive system is authenticated to use a bias-based service; and
dispatching the job request to the selected machine learning model in response to determining that the distributed cognitive system is authenticated to use the bias based service.

14. The information handling system of claim 8 wherein each one of the plurality of machine learning models is instantiated on an orchestration plane in the distributive cognitive system

15. A computer program product stored in a computer readable storage medium, comprising computer program code that, when executed by an information handling system, causes the information handling system to perform actions comprising:
receiving a job request from an entity operating in a distributive cognitive system, wherein the job request comprises one or more biasing parameters;
evaluating the one or more biasing parameters against a plurality of machine learning model bias characteristics corresponding to a plurality of machine learning models;
selecting one of the plurality of machine learning models based on the evaluating; and
assigning the job request to the selected machine learning model.

16. The computer program product of claim 15 wherein the information handling system performs further actions comprising:
receiving, from each of the plurality of machine learning models, their corresponding one of the plurality of bias characteristics prior to receiving the job request, wherein each of the plurality of bias characteristics comprise one or more bias features and one or more weightage factors.

17. The computer program product of claim 16 wherein the information handling system performs further actions comprising:
grouping the plurality of machine learning models into a set of machine learning model groups based on their corresponding one or more bias features and their one or more weightage factors.

18. The computer program product of claim 17 wherein the information handling system performs further actions comprising:
receiving a list of fake features from each of the plurality of machine learning models; and
grouping the plurality of machine learning models into the set of machine learning model groups based on their corresponding one or more bias features, their one or more weightage factors, and their corresponding list of fake features.

19. The computer program product of claim 18 wherein the information handling system performs further actions comprising:
identifying one of the set of machine learning model groups that comprises at least one fake feature that matches at least one of the one or more biasing parameters; and
omitting the identified machine learning model group from the evaluating.

20. The computer program product of claim 15 wherein the information handling system performs further actions comprising:
determining whether the distributed cognitive system is authenticated to use a bias-based service; and
dispatching the job request to the selected machine learning model in response to determining that the distributed cognitive system is authenticated to use the bias based service.
The method of claim 1 wherein each of the plurality of machine learning models are instantiated on an orchestration plane in the distributive cognitive system.
